(19) United States
(12) Patent Application Publication
(10) Pub. No.: US 2012/0162372 A1
(43) Pub. Date: Jun. 28, 2012

(54) APPARATUS AND METHOD FOR CONVERGING REALITY AND VIRTUALITY IN A MOBILE ENVIRONMENT

(75) Inventor: Sang-Won GHYME, Daejeon (KR)

(73) Assignee: Electronics and Telecommunications Research Institute, Daejeon-city (KR)

(21) Appl. No.: 13/333,459

(22) Filed: Dec. 21, 2011

(30) Foreign Application Priority Data
Dec. 22, 2010 (KR) 10-2010-0132874
Mar. 22, 2011 (KR) 10-2011-0025498

(51) Int. Cl. H04N 13/02

(52) U.S. Cl. 348/46; 348/E13.074

(57) ABSTRACT

Disclosed herein are an apparatus and a method for converging reality and virtuality in a mobile environment. The apparatus includes an image processing unit, a real environment virtualization unit, and a reality and virtuality convergence unit. The image processing unit corrects real environment image data captured by at least one camera included in a mobile terminal. The real environment virtualization unit generates real object virtualization data virtualized by analyzing each real object of the corrected real environment image data in a three-dimensional (3D) fashion. The reality and virtuality convergence unit generates a convergent image, in which the real object virtualization data and at least one virtual object of previously stored virtual environment data are converged by associating the real object virtualization data with the virtual environment data, with reference to location and direction data of the mobile terminal.

### CROSS REFERENCE TO RELATED APPLICATION

This application claims the benefit of Korean Patent Application Nos. 10-2010-0132874 and 10-2011-0025498, filed on Dec. 22, 2010 and Mar. 22, 2011, respectively, which are hereby incorporated by reference in their entirety into this application.

### BACKGROUND OF THE INVENTION

1. Technical Field

The present invention relates generally to an apparatus and a method for converging reality and virtuality in a mobile environment and, more particularly, to an apparatus and a method for converging reality and virtuality via a mobile terminal.

2. Description of the Related Art

In order to merge real and virtual environments, conventional augmented reality, mixed reality, and extended reality techniques have been used. These techniques share common concept, and they all have the object of providing supplemental information by combining a real environment with a virtual object or information. For example, the techniques may be used to provide additional information about exhibits in a museum via a display, or provide an additional service related to one or more virtual characters that operate in conjunction with a moving image.

A system for augmented reality chiefly includes a high-performance server, a camera, location tracking sensors, and a display. The system captures an image using the camera in a real environment, determines the location of the camera or the location of a specific real object (i.e., a marker) in the real environment by using the location tracking sensor, maps virtual objects onto the real environment image using location tracking, converges the virtual objects and the real environment image, and provides an augmented image in real time.

In an augmented image provided as described above, it is possible to insert virtual objects onto a real environment and provide a resulting image, but it is impossible to insert virtual objects among real objects in a real environment and provide a resulting image. There is a need for a technique for virtualizing a real environment itself so as to perform such insertion. The virtualization of a real environment includes dividing the real environment into a background and real objects using spatial analysis and converting the real objects into virtual objects. Using this method, some other virtual object can be easily inserted among the virtual objects extracted from the real object. It is however very difficult to analyze three-dimensional (3D) real space using only a two-dimensional (2D) image of the real environment. For the analysis of 3D real space, various methods exist, and a representative one thereof is a range imaging technique.

In the range imaging technique, a disparity map (i.e., a 2D image having depth information) is generated using a sensor device. The range imaging technique is classified as a passive method using only a camera without requiring any restriction or an active method using a beam projector and a camera.

Furthermore, the range imaging technique is classified as a stereo matching method using a stereo camera or a coded aperture method according to the type of sensor, as a sheet-of-light triangulation method or a structured light method that analyzes a resulting image of an object using a visible ray or an infrared pattern, and as a Time-Of-Flight (TOF) method or an interferometry method that uses light pulses instead of electric waves, like a method using a radar.

The stereo matching method is advantageous in that it is amenable to being applied to portable terminals because it uses two cameras, but is problematic in that the time calculations take is excessively long. Furthermore, the structured light method or the TOF method may be used for real-time processing, but are problematic in that they are possible only in an indoor environment or maybe they cannot be used to capture images using several cameras at the same time and they are expensive. Furthermore, the stereo matching method or the structured light method requires an image correction process for solving lens distortion and a pre-processing process for calculating the location and direction of a camera because the camera is used. The pre-processing process requires a lot of time and has difficulty in newly calculating the location and direction of the camera for each frame when the camera is movable.

As described above, a structure-from-motion technique requiring only one camera is also used in addition to the range imaging technique for 3D spatial analysis. In the structure-from-motion technique, real-time space analysis is impossible when one camera has to obtain moving image data over a long period of time from in several directions, but is possible if a sensor or several cameras are used at the same time. In the range imaging technique, a disparity map for all captured objects is not perfectly generated, but a background and a real object may be easily separated from each other based on the depth information of the disparity map (i.e., the results of the range imaging technique) or the disparity map may be converted into point cloud data, the 3D mesh of the real object may be generated from the point cloud data using a triangulation method, and be then used as a virtual object.

The generation of the 3D mesh of the real object, that is the virtualization of the real object, is also called a 3D shape restoration technique. In the 3D mesh generated using the range imaging technique, not the entire shape of the real object, but only part of the shape is restored. Accordingly, in order to restore the entire shape of the real object, partial 3D meshes generated from disparity maps captured in several directions have to be joined and patched using a mesh warping technique. For example, when the motion of a real object having a skeleton structure similar to that of a person is captured using the range imaging technique, a partial mesh captured in one direction of the real object is restored. The entire shape of the real object is restored for each frame using a technique for estimating the remaining mesh from the partial mesh. The motion of the shape is generated by analyzing the posture of a shape. Alternatively, the action has to be generated by assigning the characteristic point of each joint and tracking the characteristic point of the joint with reference to depth information of the characteristic point from the partially restored displacement map.

As described above, the 3D spatial analysis-related techniques are problematic in that they are used in very limited fields, such as a 3D scanner operating in a fixed place, because the time calculation takes is long, real-time processing is difficult, and an expensive high performance server is used.

### SUMMARY OF THE INVENTION

Accordingly, the present invention has been made keeping in mind the above problems occurring in the prior art, and an object of the present invention is to provide an apparatus and a method for converging and providing real and virtual environments in a mobile terminal.

In order to accomplish the above object, the present invention provides an apparatus for converging reality and virtuality in a mobile environment, including an image processing unit for correcting real environment image data captured by at least one camera included in a mobile terminal; a real environment virtualization unit for generating real object virtualization data virtualized by analyzing each real object of the corrected real environment image data in a 3D fashion; and a reality and virtuality convergence unit for generating a convergent image, in which the real object virtualization data and at least one virtual object of previously stored virtual environment data have been converged by associating the real object virtualization data with the virtual environment data, with reference to location and direction data of the mobile terminal.

The real environment virtualization unit may include: a multi-image matching unit for generating disparity map data by analyzing the corrected real environment image data in a 3D fashion; a 3D shape restoration unit for generating real object disparity map data for each individual real object using the disparity map data and generating partial 3D mesh data of the real object using the real object disparity map data; and a mesh warping unit for generating completed 3D mesh data capable of completely representing the real object, by performing mesh warping that joins and patches the partial 3D mesh data restored in various directions with respect to the real object and then filling the remaining empty mesh part by referring to edges thereof.

The real environment virtualization unit may further include an estimation conversion unit for generating estimated 3D mesh data by estimating an empty mesh part in the currently restored partial 3D mesh data with reference to the completed 3D mesh data and generating real object rigging data using the estimated 3D mesh data.

The estimation conversion unit may generate a skeleton structure and motion data using the estimated 3D mesh data, determine mesh deformation attributable to the motion of the real object using the skeleton structure and the motion data, and generate the real object rigging data using the mesh deformation.

The estimation conversion unit may include a virtualization data generation unit for generating the real object virtualization data using the completed 3D mesh data, the skeleton structure and the motion data, and the real object rigging data.

The 3D shape restoration unit may convert the real object disparity map data into point cloud data and then generate the partial 3D mesh data using a triangulation method.

The virtualization data generation unit may generate individual virtualized data for each individual real object using the completed 3D mesh data, the skeleton structure and the motion data, and the real object rigging data, and generate the real object virtualization data by collecting the individual virtualized data for each individual real object.

The reality and virtuality convergence unit may generate convergent space data by converging the real object virtualization data and the virtual environment data with reference to the location and direction data of the mobile terminal, and generate the convergent image by rendering the convergent space data.

Additionally, in order to accomplish the above object, the present invention provides a method of converging reality and virtuality in a mobile environment, including correcting real environment image data captured by at least one camera included in a mobile terminal; generating real object virtualization data virtualized by analyzing a real object of the corrected real environment image data in a 3D fashion; receiving location and direction data of the mobile terminal; and providing a convergent image by composing the real object virtualization data and previously stored virtual environment data to be converged with reference to the location and direction data of the mobile terminal.

The generating real object virtualization data may include generating disparity map data by analyzing the corrected real environment image data in a 3D fashion; generating real object disparity map data for each individual real object using the disparity map data and generating partial 3D mesh data of the real object using the real object disparity map data; and generating completed 3D mesh data capable of completely representing the real object, by performing mesh warping that joins and patches the partial 3D mesh data restored in various directions with respect to the real object and then tilling the remaining empty mesh part by referring to edges thereof

The generating real object virtualization data may include generating estimated 3D mesh data by estimating an empty mesh part in the currently restored partial 3D mesh data with reference to the completed 3D mesh data; generating skeleton structure and motion data by analyzing the estimated 3D mesh data and analyzing a motion of the real object; determining mesh deformation attributable to the motion of the real object and generating real object rigging data based on the determined mesh deformation; and generating the real object virtualization data using the completed 3D mesh data, the skeleton structure and motion data, and the real object rigging data

The providing a convergent image may include generating convergent space data by converging the real object virtualization data and the virtual environment data with reference to the location and direction data of the mobile terminal; and generating the convergent image by rendering the convergent space data.

The generating partial 3D mesh data may include converting the real object disparity map data into point cloud data; and generating the partial 3D mesh data by applying a triangulation method to the point cloud data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram showing a reality and virtuality convergence apparatus in a mobile environment according to an embodiment of the present invention;

FIG. 2 is a schematic diagram showing the real environment virtualization unit of the reality and virtuality convergence apparatus shown in FIG. 1;

FIG. 3 is a flowchart illustrating the flow in which the reality and virtuality convergence apparatus shown in FIG. 1 converges real and virtual environments and provides a convergent image; and

FIG. 4 is a flowchart illustrating the flow in which real object virtualization data is generated according to an embodiment of the present invention.

### DESCRIPTION OF THE PREFERRED EMBODIMENTS

Reference now should be made to the drawings, throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

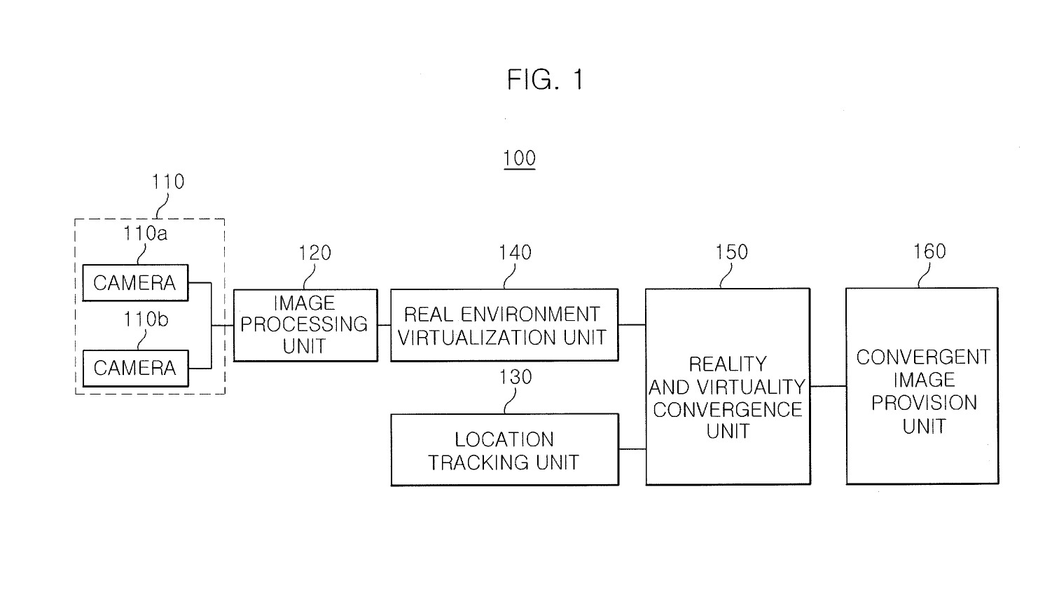

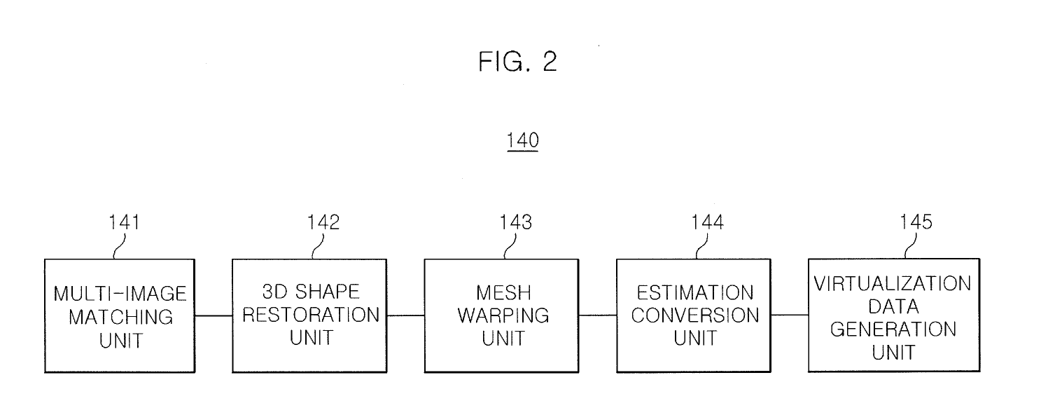

FIG. 1 is a schematic diagram showing a reality and virtuality convergence apparatus in a mobile environment according to an embodiment of the present invention, and FIG. 2 is a schematic diagram showing the real environment virtualization unit of the reality and virtuality convergence apparatus shown in FIG. 1.

As shown in FIG. 1, the reality and virtuality convergence apparatus 100 according to the embodiment of the present invention is included in a mobile terminal, and functions to convert each object in a real environment into a 3D virtual object and provide a convergent image in which one or more real objects and one or more virtual objects have been converged. The reality and virtuality convergence apparatus 100 includes an image input unit 110, an image processing unit 120, a location tracking unit 130, a real environment virtualization unit 140, a reality and virtuality convergence unit 150, and a convergent image provision unit 160.

The image input unit 110 includes at least one camera, and transfers image data about a real environment captured by the at least one camera, to the image processing unit 120. In the example disclosed herein, it is assumed that two cameras 110a and 110b are included in the image input unit 110, and the cameras 110a and 110b looks toward different directions.

The image processing unit 120 receives the real environment image data from the image input unit 110, and generates corrected real environment image data by correcting the real environment image data.

The location tracking unit 130 tracks and stores the absolute location and direction data information of the mobile terminal.

The real environment virtualization unit 140 generates real object virtualization data about a set of all the virtualized real objects by converting the corrected real environment image data received from the image processing unit 120. As shown in FIG. 2, the real environment virtualization unit 140 includes a multi-image matching unit 141, a 3D shape restoration unit 142, a mesh warping unit 143, an estimation conversion unit 144, and a virtualization data generation unit 145.

The multi-image matching unit 141 receives the corrected real environment image data from the image processing unit 120. The multi-image matching unit 141 generates disparity map data by performing multi-image matching that analyzes the corrected real environment image data in a 3D fashion.

The 3D shape restoration unit 142 generates real object disparity map data for each real object by separating the real object in the real environment from the disparity map data. The 3D shape restoration unit 142 converts the real object disparity map data into point cloud data, generates the partial 3D mesh data of the real object (hereinafter referred to as “partial 3D mesh data”) by performing a triangulation method, and restores a real object 3D shape.

The mesh warping unit 143 generates the completed 3D mesh data for the visualized representation of the real object (hereinafter referred to as “completed 3D mesh data”), by performing mesh warping that joins and patches the partial 3D mesh data restored from the image data captured in different directions and corrected and then filling the remaining empty mesh part by referring to edges thereof.

The estimation conversion unit 144 generates real object 3D estimation mesh data (hereinafter referred to as “estimated 3D mesh data”) by performing mesh estimation that estimates each empty mesh part in the currently restored 3D partial mesh data with reference to the completed 3D mesh data. Furthermore, the estimation conversion unit 144 generates the skeleton structure and motion data of a corresponding real object by analyzing the estimated 3D mesh data, and then performs motion analysis. The estimation conversion unit 144 analyzes the 3D mesh data and the skeleton structure and motion data of the real object, and generates real object rigging data by performing conversion that determines mesh deformation attributable to the motion of the skeleton.

The virtualization data generation unit 145 generates virtualized real object data about an individual real object (hereinafter referred to as “individual virtualized data”) using the completed 3D mesh data, the skeleton structure and motion data of the real object, and the real object rigging data. The virtualization data generation unit 145 generates real object virtualization data, that is, a set of pieces of virtualized real object data, using the individual virtualized data about the individual real object in the real environment.

Referring back to FIG. 1, the reality and virtuality convergence unit 150 generates convergent space data by converging the real object virtualization data and the virtual environment image data with reference to the absolute location and direction data information of the mobile terminal. That is, the reality and virtuality convergence unit 150 makes coincident the coordinate axis of the virtualized real environment with the coordinate axis of the virtual environment with reference to the absolute location and direction data information of the mobile terminal and the relative location and direction data of the at least one camera 110a and 110b which are generated during the process of conversion into the 3D real object virtualization data. Furthermore, the reality and virtuality convergence unit 150 generates a convergent image in which the real object and the virtual object have been converged by rendering the convergent space data. Here, the virtual environment image data may be provided by a server that operates in conjunction with the mobile terminal, and may be previously generated and stored so that it can operate in conjunction with the real object.

For example, if the real environment image data captured by the cameras is a train station, the real object virtualization data for the train station has been generated, and a bulletin for notifying of the virtual train departure and arrival times and hanging in the air captured by the cameras is previously stored as virtual environment data; the reality and virtuality convergence unit 150 generates and provides a convergent image in which the train station captured by the cameras when a train is arrived and the previously stored image data of the bulletin are converged.

The convergent image provision unit 160 receives the convergent image from the reality and virtuality convergence unit 150, and displays the convergent image on the display unit (not shown) of the mobile terminal.

The real object according to this embodiment of the present invention may be map data, event information, transportation means or an object, such as a person or a building, which can be identified using a visible ray camera, or a special object which can be identified using an infrared camera. The real object may be an external real object viewed by a user via a camera, or may be the user himself or herself. That is, when the face, back of the hand, and whole body of a user are captured in front of a camera, the user may be virtualized and converted into a virtual character. Furthermore, virtualization may be performed so that each button of a virtual menu board viewed via a camera can be pressed. This function does away with the necessity of a touch panel that is mounted on the display unit of a mobile terminal, thereby reducing the manufacturing cost of the system.

Although in the embodiment of the present invention, the reality and virtuality convergence unit 150 of the reality and virtuality convergence apparatus 100 has been illustrated as being included and operated in the mobile terminal, the present invention is not limited thereto. If the performance of a Central Processing Unit (CPU) that controls a mobile terminal is low, the reality and virtuality convergence unit 150 may be included and operated in a server that operates in conjunction with the mobile terminal. Here, if the real object virtualization data obtained by virtualizing the real environment captured by the mobile terminals of persons is allowed to be concentrated on the server, a mirror world may be constructed more conveniently by joining and patching the gathered real object virtualization data and thereby incorporating a consistently updatable real world into a virtual environment.

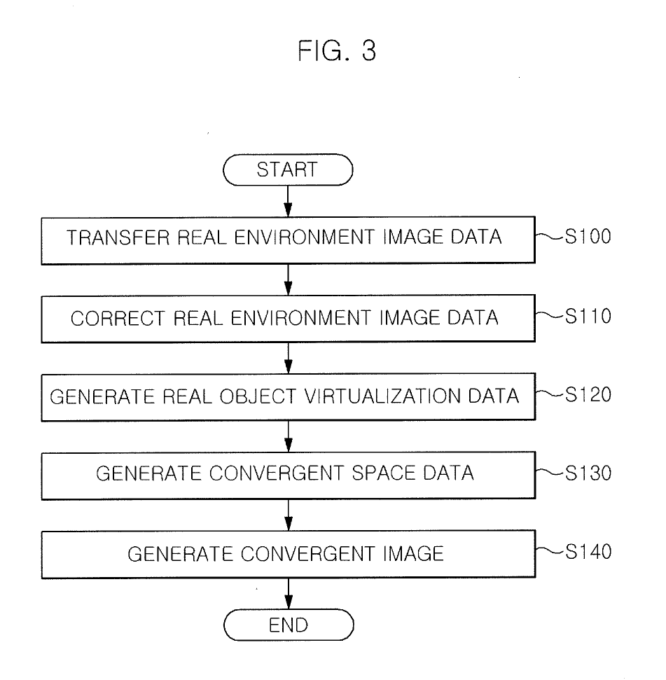

FIG. 3 is a flowchart illustrating the flow in which the reality and virtuality convergence apparatus shown in FIG. 1 converges real and virtual environments and provides a convergent image.

Referring to FIGS. 1 and 3, the image input unit 110 of the reality and virtuality convergence apparatus 100 according to the embodiment of the present invention transfers the image data of a real environment, representative of reality captured by the one or more cameras 110a and 110b, to the image processing unit 120 at step S100.

The image processing unit 120 receives the real environment image data from the image input unit 110 and generates corrected real environment image data by correcting the real environment image data at step S110. The image processing unit 120 transfers the corrected real environment image data to the real environment virtualization unit 140.

The real environment virtualization unit 140 generates real object virtualization data about a set of all virtualized real objects in a real environment by analyzing the corrected real environment image data at step S120. The real environment virtualization unit 140 generates convergent space data by converging the real object virtualization data and previously prepared virtual environment image data with reference to the absolute location and direction data information of the mobile terminal received from the location tracking unit 130 at step S130. The reality and virtuality convergence unit 150 generates a convergent image in which the real objects and the virtual objects have been converged by rendering the convergent space data at step 5140. The reality and virtuality convergence unit 150 transfers the convergent image to the convergent image provision unit 160.

The convergent image provision unit 160 provides the convergent image using the display unit (not shown) of the mobile terminal.

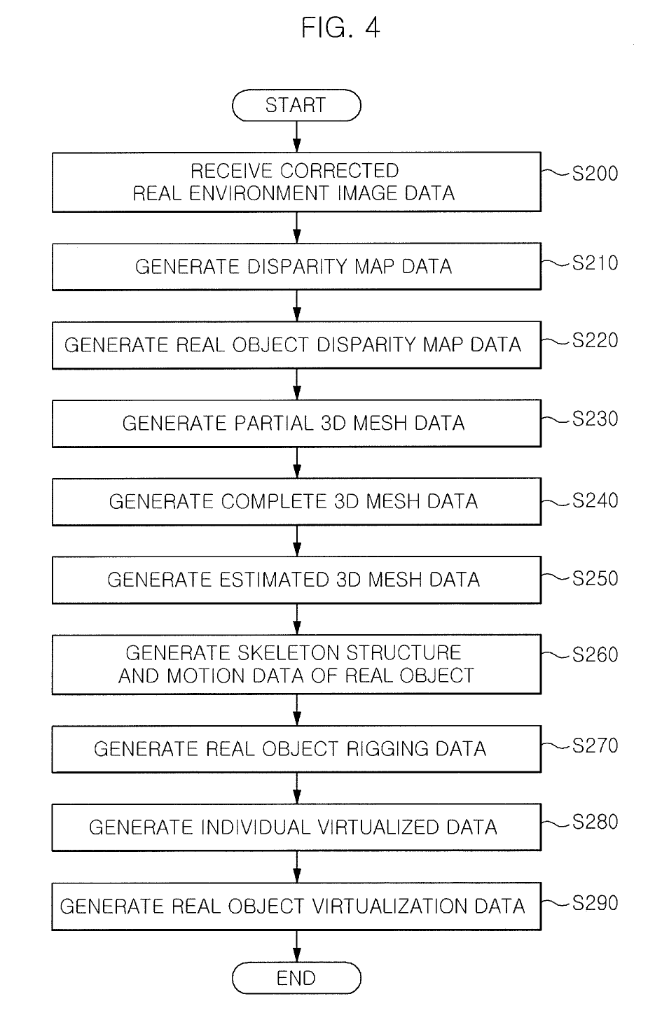

FIG. 4 is a flowchart illustrating the flow in which real object virtualization data is generated according to an embodiment of the present invention.

As shown in FIG. 4, in the reality and virtuality convergence apparatus 100 according to the embodiment of the present invention, the multi-image matching unit 141 of the real environment virtualization unit 140 receives the corrected real environment image data from the image processing unit 120 at step S200. The reality and virtuality convergence unit 140 generates disparity map data by performing multi-image matching that analyzes the corrected real environment image data in a 3D fashion at step S210.

The 3D shape restoration unit 142 generates real object disparity map data for each individual real object by separating the individual real object in the real environment from the disparity map data at step S220. The 3D shape restoration unit 142 converts the real object disparity map data into point cloud data and generates partial 3D mesh data by restoring each real object 3D shape using a triangulation method at step S230.

The mesh warping unit 143 generates completed 3D mesh data for the visualized representation of the real object, by joining and patching the partial 3D mesh data restored from the image data captured in different directions and corrected and then filling the remaining empty mesh part by referring to edges thereof, at step S240, wherein the remaining empty part may be the part that cannot be captured and an example of such part is the sole of a foot.

The estimation conversion unit 144 generates estimated 3D mesh data by performing mesh estimation on an empty mesh part in the currently restored partial 3D mesh data with reference to the completed 3D mesh data at step S250. The estimation conversion unit 144 generates the skeleton structure and motion data of a corresponding real object by analyzing the motion of the estimated 3D mesh data at step S260. The estimation conversion unit 144 analyzes the complete 3D mesh data and the skeleton structure and motion data of the real object and generates real object rigging data by performing conversion that determines mesh deformation attributable to the motion of the skeleton at step S270.

The virtualization data generation unit 145 generates individual virtualized data using the completed 3D mesh data, the skeleton structure and motion data of the real object, and the real object rigging data at step S280. The virtualization data generation unit 145 generates real object virtualization data (i.e., a set of virtualized real object data) using the individual virtualized data for each individual object in the real environment at step S290.

In the embodiment of the present invention, the real environment has been illustrated as being virtualized using the at least one camera. If a single camera is mounted on a mobile terminal, it is difficult to virtualize a real environment using an image captured in the state in which the camera is fixed. Accordingly, the real environment has to be inconveniently virtualized using matching between an image in a previously captured frame and an image in a currently captured frame by continuously capturing frames in various directions while moving the camera. If images captured by the mobile terminals of other persons within a short distance range are shared via a server, a mobile terminal with just one camera may be useful because a number of images that may be matched with each other in various directions can be secured. Furthermore, if three cameras are mounted on one mobile terminal, the accuracy of an image matching process increases, but the computational load increases. For this reason, in the embodiment of the present invention, a real environment has been illustrated as being virtualized using the two cameras.

As described above, in this embodiment of the present invention, a mobile terminal generates real object virtualization data by virtualizing all the objects of a real environment, generates a convergent image, in which the real object and a virtual object are converged, by associating the real object virtualization data with previously stored virtual environment image data with reference to the absolute location and direction data information of the mobile terminal, and provides the convergent image. Accordingly, an image service in which reality and virtuality are converged can be provided while moving.

Furthermore, in this embodiment of the present invention, a real environment captured by a mobile terminal is analyzed in a 3D fashion and is then virtualized. A previously stored 3D virtual environment is inserted into and associated with the real environment. Accordingly, an image service in which reality and virtuality are converged can be provided more conveniently in real time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for converging reality and virtuality in a mobile environment, comprising:
an image processing unit for correcting real environment image data captured by at least one camera included in a mobile terminal;
a real environment virtualization unit for generating real object virtualization data virtualized by analyzing each real object of the corrected real environment image data in a three-dimensional (3D) fashion; and
a reality and virtuality convergence unit for generating a convergent image, in which the real object virtualization data and previously stored virtual environment data are converged by associating the real object virtualization data with the virtual environment data, with reference to location and direction data of the mobile terminal.

2. The apparatus as set forth in claim 1, wherein the real environment virtualization unit comprises:
a multi-image matching unit for generating disparity map data by analyzing the corrected real environment image data in a 3D fashion;
a 3D shape restoration unit for generating real object disparity map data for each individual real object using the disparity map data and generating partial 3D mesh data using the real object disparity map data; and
a mesh warping unit for generating completed 3D mesh data, by performing mesh warping that collects the partial 3D mesh data in various directions and joins and patches the partial 3D mesh data and then filling remaining empty mesh part.

3. The apparatus as set forth in claim 2, wherein the real environment virtualization unit further comprises an estimation conversion unit for generating estimated 3D mesh data by estimating an empty mesh part in the generated partial 3D mesh data with reference to the completed 3D mesh data and generating real object rigging data by using the estimated 3D mesh data

4. The apparatus as set forth in claim 3, wherein the estimation conversion unit generates a skeleton structure and motion data by using the estimated 3D mesh data, determines mesh deformation attributable to a motion of the real object by using the skeleton structure and the motion data, and generates the real object rigging data by using the mesh deformation.

5. The apparatus as set forth in claim 4, wherein the estimation conversion unit comprises a virtualization data generation unit for generating the real object virtualization data by using the completed 3D mesh data, the skeleton structure and the motion data, and the real object rigging data

6. The apparatus as set forth in claim 2, wherein the 3D shape restoration unit converts the real object disparity map data into point cloud data and then generates the partial 3D mesh data by using a triangulation method.

7. The apparatus as set forth in claim 2, wherein the virtualization data generation unit generates individual virtualized data for each individual real object using the completed 3D mesh data, the skeleton structure and the motion data, and the real object rigging data, and generates the real object virtualization data by collecting the individual virtualized data for each individual real object.

8. The apparatus as set forth in claim 1, wherein the reality and virtuality convergence unit generates convergent space data by converging the real object virtualization data and the virtual environment data with reference to the location and direction data of the mobile terminal, and generates the convergent image by rendering the convergent space data.

9. A method of converging reality and virtuality in a mobile environment, comprising:
correcting real environment image data captured by at least one camera included in a mobile terminal;
generating real object virtualization data virtualized by analyzing a real object of the corrected real environment image data in a 3D fashion;
receiving location and direction data of the mobile terminal; and
providing a convergent image by converging the real object virtualization data and previously stored virtual environment data to be converged, with reference to the location and direction data of the mobile terminal.

10. The reality and virtuality convergence method as set forth in claim 9, wherein the generating real object virtualization data comprises:
generating disparity map data by analyzing the corrected real environment image data in a 3D fashion;
generating real object disparity map data for each individual real object using the disparity map data and generating partial 3D mesh data by using the real object disparity map data; and
generating completed 3D mesh data, by performing mesh warping that collects the partial 3D mesh data in various directions and joins and patches the partial 3D mesh data and then filling remaining empty mesh part.

11. The reality and virtuality convergence method as set forth in claim 10, wherein the generating real object virtualization data comprises:
generating estimated 3D mesh data by estimating an empty mesh part in the generated partial 3D mesh data with reference to the completed 3D mesh data;
generating skeleton structure and motion data by analyzing the estimated 3D mesh data, and then analyzing a motion of the real object;
determining mesh deformation attributable to the motion of the real object and generating real object rigging data based on the determined mesh deformation; and
generating the real object virtualization data by using the completed 3D mesh data, the skeleton structure and motion data, and the real object rigging data.

12. The reality and virtuality convergence method as set forth in claim 9, wherein the providing a convergent image comprises:
generating convergent space data by converging the real object virtualization data and the virtual environment data with reference to the location and direction data of the mobile terminal; and
generating the convergent image by rendering the convergent space data.

13. The reality and virtuality convergence method as set forth in claim 10, wherein the generating partial 3D mesh data comprises:
converting the real object disparity map data into point cloud data; and
generating the partial 3D mesh data by applying a triangulation method to the point cloud data.
